(19) United States
(12) Patent Application Publication
(10) Pub. No.: US 2026/0321785 A1
(43) Pub. Date: Oct. 15, 2026

(54) INTERCELLULAR COOLING PLATE FOR BATTERY, BATTERY, MOTOR VEHICLE, AND METHOD FOR PRODUCING AN INTERCELLULAR COOLING PLATE

(71) Applicant: AUDI AG, Ingolstadt (DE)

(72) Inventors: Carsten LORENZ, Reichertshofen (DE); Eduard MAIN, Buxheim (DE); Manuel LIEDKE-SOBOTTA, Striegistal (DE); Thorsten LAHMANN, Meine (DE); Marko PESTER, Chemnitz (DE)

(73) Assignee: AUDI AG, Ingolstadt (DE)

(21) Appl. No.: 19/573,257

(22) Filed: Mar. 20, 2026

(30) Foreign Application Priority Data
Apr. 9, 2025 (DE) 102025114025.1

(51) Int. Cl. H01M 10/6557; B60L 58/26; H01M 10/613; H01M 10/625; H01M 10/647; H01M 10/6561; H01M 50/209; H01M 50/242; H01M 50/249

(52) U.S. Cl. CPC H01M 10/6557; H01M 10/613; H01M 10/625; H01M 10/647; H01M 10/6561; H01M 50/209; H01M 50/242; H01M 50/249; B60L 58/26; H01M 2220/20

(57) ABSTRACT

An intercellular cooling plate for positioning between at least two battery cells of a battery. The intercellular cooling plate includes an interior having at least one first cooling channel through which a coolant can flow, a first plate wall, and a second plate wall, which are opposite to one another with respect to a first direction and which bound the interior in and against the first direction. At least one pressure chamber separated from the cooling channel, which is filled with a fluid having a specific fluid pressure, is arranged in the interior.

### FIELD

The invention relates to an intercellular cooling plate for positioning between at least two battery cells of a battery, wherein the intercellular cooling plate comprises an interior having at least one first cooling channel through which a coolant can flow, a first plate wall, and a second plate wall which are opposite to one another with respect to a first direction and which bound the interior in and against the first direction. Furthermore, the invention also relates to a battery, a motor vehicle, and a method for producing an intercellular cooling plate.

### BACKGROUND

Intercell cooling can be provided by an intercellular cooling plate. This can be positioned between battery cells, and the battery cells can be temperature controlled by a coolant flowing through the cooling channel. In addition, battery cells are subject to so-called swelling. In the course of such swelling, battery cells expand. The battery cells expand increasingly, in particular over their lifespan, and this age-related swelling is superimposed on a charge-related swelling, according to which the battery cells swell when charging and subside again when discharging. Cell growth therefore takes place over the lifespan and cyclization of the cells. The pressure on the cells thus increases continuously or progressively over their lifespan. This cell growth should be able to be compensated for by a material or component located between the cells. If the cells cannot expand, this significantly reduces the lifespan of the battery cells.

If a cooling plate is positioned between the cells that is designed to be so rigid or stable that the adjacent battery cells cannot expand, this is correspondingly bad for the lifespan of the battery cells. If, on the other hand, a cooling plate is designed to be so soft or flexible that it is compressed due to cell swelling, there is a risk that the cooling channel(s) of the cooling plate will also be compressed, which impairs or even prevents the coolant medium from flowing through Therefore, it would be desirable to better harmonize the functions of cooling and swelling compensation by way of such a cooling plate.

### SUMMARY

The object of the present invention is therefore to provide an intercellular cooling plate, a battery, a motor vehicle, and a method that allow the best possible swelling compensation and also the best possible cooling.

This object is achieved by an intercellular cooling plate, a battery, a motor vehicle, and a method. Advantageous embodiments of the invention are the subject matter of the claims, the description, and the figures.

An intercellular cooling plate according to the invention for positioning between at least two battery cells of a battery comprises an interior having at least one first cooling channel through which a coolant can flow, a first plate wall, and a second plate wall, which are opposite to one another with respect to a first direction and bound the interior in and against the first direction. At least one pressure chamber separated from a cooling channel, which is filled with a fluid having a specific fluid pressure, is arranged in the interior.

The fluid pressure of the fluid can advantageously counteract compression of the intercellular cooling plates. In particular, the compression properties of the intercellular cooling plate can be adjusted in a defined manner by targeted adjustment or selection of the specific fluid pressure. Excessive compression of the intercellular cooling plate, which could result in compression of at least one first cooling channel, can thus advantageously be prevented more effectively. By suitably selecting the fluid pressure, a certain degree of compressibility can still be provided by the intercellular cooling plate, which advantageously permits swelling compensation, i.e. it enables the adjacent battery cells to expand. The adjustment of the compression properties of the intercellular cooling plate can therefore be advantageously controlled by the fluid pressure of the fluid, and thus independently of, for example, the coolant pressure of the coolant medium or coolant flowing through the cooling channel. In other words, it is not necessary to set a particularly high coolant pressure during operation of the intercellular cooling plate in order to prevent excessive compression of the intercellular cooling plate. This function can, however, be taken over by the fluid pressure of the fluid located in the pressure chamber. This allows the cooling function and the swelling compensation function to be much better harmonized by way of the intercellular cooling plate. Because the fluid in the pressure chamber prevents excessive compression of the intercellular cooling plate, it is also possible to make the intercellular cooling plate itself, or its plate walls, significantly thinner and less stable. This in turn permits significantly better heat transfer between battery cells and the intercellular cooling plate, and also saves material, weight, and installation space. Furthermore, the fluid pressure increases with increasing compression of the intercellular cooling plate, since the fluid is enclosed in the pressure chamber. An increasing compression, for example, caused by the swelling of the adjacent battery cells, can thus be counteracted by an even greater opposing force. This in turn permits particularly good swelling compensation.

The pressure chamber is designed in particular as a closed space, in particular a fluid-tight space. The fluid is accordingly enclosed in the pressure chamber.

The fluid can generally be a liquid and/or a gas. It is particularly advantageous if the fluid is at least partly a gas, i.e. a substance that is gaseous under normal conditions and/or standard conditions. A gas is also to be able to be understood as a gas mixture. Air or another gas can be used as the gas. A liquid can also be fractionally present in the pressure chamber, although this is less preferred. The fluid can also only be a gas. The pressure chamber can therefore, for example, be filled only with gas.

The compression properties of a gas have a particularly positive effect on the compression properties of the intercellular cooling plate. Compression of the intercellular cooling plate therefore results in compression of the fluid located in the pressure chamber. The fluid pressure in the pressure chamber thus increases, due to which with increasing compression of the pressure chamber, an increasing counterforce can be exerted against the compression due to the rising fluid pressure. In particular, due to the higher compressibility of the gas compared to a liquid, better compressibility of the intercellular cooling plate can also be provided, and a force-displacement curve optimized for battery cells and their swelling.

According to a further advantageous embodiment of the invention, the pressure chamber borders the first and second plate walls. In this way, compression of the intercellular cooling plate can be transferred to the pressure chamber particularly easily. The intercellular cooling plate is therefore designed in such a way that compression of the intercellular cooling plate results in compression of the pressure chamber and thus of the fluid located in the pressure chamber. Therefore, if a distance between the first and second plate walls decreases accordingly, the pressure chamber is also compressed accordingly. Conversely, the fluid pressure in the pressure chamber can be transferred to the first and second plate walls in this way.

Accordingly, it is a further very advantageous embodiment of the invention if the intercellular cooling plate is compressible with respect to the first direction and with respect to a defined initial state, in particular elastically compressible, in particular in such a way that a distance between the first and second plate wall is reducible in at least one area of the intercellular cooling plate in relation to an initial distance that the first and second plate wall have in the defined initial state. The elastic properties can be easily provided by the fluid received in the pressure chamber, in particular in combination with an outer wall of the intercellular cooling plate that is flexible at least in some areas. For example, the first and/or second plate wall can be designed to be flexible or thin-walled, at least in some areas, as part of this wall. Border areas, in which the first and second plate wall are connected to one another, can also be designed as flexible or thin-walled at least in some areas as part of this wall.

The initial state of the intercellular cooling plate can refer to a state of the intercellular cooling plate in which it is installed between the at least two battery cells of the battery, which are in particular at the beginning of their service life, i.e. when the intercellular cooling plate has not yet been compressed by cell swelling, or at least not to a significant extent. The defined initial state can additionally or alternatively be defined in such a way that it differs from a maximally compressed state of the intercellular cooling plate, in which no further elastic and/or damage-free compression of the intercellular cooling plate is possible, and the distance between the first and second cooling plate is greater in at least one area in the initial state than in the maximally compressed state.

Starting from this initial state, a distance between the two plate walls is therefore reducible, at least in one area or at least locally. In this case, a minimal distance or minimum distance between the two plate walls can be optimally defined, which it is not possible to fall below, i.e. which the plate walls have, for example, in the above-mentioned maximally compressed state. The minimum distance is preferably not zero. Therefore, in this maximally compressed state, the plate walls preferably do not contact one another directly. This can be ensured in a variety of ways. For example, this can be ensured solely on the basis of the pressure chamber and the fluid pressure prevailing therein. Additionally or alternatively, spacers can also be provided in the interior to ensure this minimum distance between the two plate walls. These spacers can be provided, for example, by the at least one first cooling channel or by other elements, such as the expansion limiting components explained below. The minimum distance can also be ensured by a combination of the modes of action of the above-mentioned elements. If, for example, the battery cells adjacent to the intercellular cooling plate expand, the intercellular cooling plate will be compressed, at least locally and in particular at most up to this minimum distance. If the adjacent battery cells subsequently subside again, or if the external pressure on the intercellular cooling plate decreases with respect to the first direction, the intercellular cooling plate can advantageously expand again due to its elastic compression properties, for example, at least to its defined initial state. This allows the intercellular cooling plate to advantageously follow the swelling movements of the battery cells. The intercellular cooling plate can also be designed in such a way that it is locally compressible differently. In other words, it is possible to compress the intercellular cooling plate to different degrees in different areas with respect to the first direction. The plate walls can accordingly be designed to be flexible enough to allow such different compression in different areas of the intercellular cooling plate. This also allows the plate walls to adapt to a changing geometry of the battery cells during swelling.

However, the intercellular cooling plate can also be designed in such a way that different degrees of compression are not possible. This can be achieved, for example, by a correspondingly stiff, for example, thicker-walled, embodiment of the plate walls.

At least in the initial state, the plate walls can be essentially flat and/or aligned parallel to one another.

According to a further advantageous embodiment of the invention, the first plate wall has a first inner side facing toward the interior and the second plate wall has a second inner side facing toward the interior, wherein a first expansion limiting component is arranged in the first inner side and a second expansion limiting component is arranged in the second inner side.

In particular, the first and second expansion limiting components make it possible to limit, at least locally, an increase of a distance between the first and second plate wall. Additionally or alternatively, it can be provided that a form fit can be formed by means of the first and second expansion limiting components when a distance between the first and second plate wall is increased. This form fit can in turn be used to at least locally limit the increase in the distance between the first and second plate walls. The increase of the distance between the first and second plate wall can thus be at least locally limited by a form fit between the first and second expansion limiting component.

In an uninstalled state of the intercellular cooling plate, the fluid pressure is preferably greater than an ambient pressure or a defined normal pressure or standard pressure. In a state installed between the at least two battery cells, the fluid pressure is typically even higher than in the uninstalled state, because the battery cells are clamped together with the intercellular cooling plate located therebetween.

Such expansion limiting has the great advantage that it makes the intercellular cooling plate particularly easy to produce and install in a battery. If, during the production of the intercellular cooling plate, the pressure chamber is filled with fluid at a fluid pressure greater than the ambient pressure, the plate walls would be pressed apart without countermeasures. This would cause the intercellular cooling plate to deform, in particular also to partially deform plastically. This could result in damage. By providing the expansion limiting components, it is advantageously possible to appropriately limit the increase in the distance between the two plate walls. As soon as the maximum distance at least locally defined by these components is reached, the expansion limiting components form a form fit with one another, which prevents the two plate walls from moving farther away from one another. This advantageously makes it possible to fill the pressure chamber with very high fluid pressures without having to fear unwanted deformation or damage to the intercellular cooling plate.

The intercellular cooling plate can also comprise multiple first and multiple second expansion limiting components. Each first expansion limiting component is assigned to a second expansion limiting component and together they form, for example, an expansion limiting pair.

According to a further advantageous embodiment of the invention, the first expansion limiting component has a hooked first end facing toward the second inner side, which is designed to form a form fit with at least a part of the second expansion limiting component, in particular wherein the second expansion limiting component has a hooked second end facing toward the first inner side, which can be brought into a form fit with the first end, in particular when or by increasing the distance between the two plate walls. In the initial state of the intercellular cooling plate, the two hooked ends of the two expansion-limiting components thus do not yet have to be engaged with one another. If the distances between the two plate walls increase, for example, during the filling of the pressure chamber with the fluid during the production of the intercellular cooling plate, the two hooked ends accordingly move towards one another until they finally engage with one another and a further increase in the distance between the areas of the plate walls where the expansion limiting components are located is no longer possible. This defines the maximum distance between the two plate walls in the area of these expansion limiting components.

In order to be able to establish a form fit between the two expansion limiting components, they do not necessarily have to be designed having hooked ends, and in particular, not necessarily both of them do. For example, a hooked end can also engage in a corresponding slot of the other expansion limiting component, and expansion of the intercellular cooling plate is possible until the hook reaches the end of the slot. Arbitrary other designs are also conceivable. However, the design having two hooked ends has the great advantage that the intercellular cooling plate can be provided by two profile components, as will be explained in more detail later, which can be pushed into one another in a direction perpendicular to the first direction in which the at least first cooling channel also extends, in particular without collision. This in turn enables particularly simple manufacturing of the intercellular cooling plate. By designing the expansion limiting components having hooked ends, a kind of locking mechanism can also be provided, which makes it possible to bring the two profile components into their intended position relative to one another by moving them towards one another in the first direction, wherein the two hooked ends of the expansion limiting components snap together or snap in one behind the other.

A hooked end is also to be understood in particular as an L-shaped angled end or an end angled by 90° or less.

According to a further advantageous embodiment of the invention, the at least one first cooling channel is arranged on the first inner side and has a distance to the second inner side at least in a defined initial state of the intercellular cooling plate, in particular in the defined initial state of the intercellular cooling plate already mentioned above. This distance advantageously ensures that the cooling channel is not compressed when the intercellular cooling plate is compressed with respect to the first direction. Furthermore, this distance ensures that the compressibility of the intercellular cooling plate is not impaired by the at least one first cooling channel. In particular, the compressibility of the intercellular cooling plate can be significantly controlled by the pressure chamber or the fluid pressure in the pressure chamber.

According to a further advantageous embodiment of the invention, the intercellular cooling plate comprises at least one second cooling channel, which is arranged in the second inner side and has a distance to the second inner side at least in a defined initial state in the intercellular cooling plate. By providing cooling channels not only directly adjacent to the first inner side, but also directly adjacent to the second inner side, the two plate walls can be cooled or controlled in temperature particularly evenly.

“At least in a defined initial state” can mean that the intercellular cooling plate can be so highly compressible that, in such a compressed state of the intercellular cooling plate in relation to the defined initial state, the first cooling channel with its channel wall can also come into contact on the second inner side. However, further measures may be provided, as explained in more detail later, which can prevent such a direct contact on the second inner side.

In particular, the intercellular cooling plate can also comprise multiple first cooling channels and multiple second cooling channels. The first cooling channels are then arranged accordingly on the first inner side and preferably extend parallel to one another. The second cooling channels are arranged accordingly on the second inner side and preferably likewise extend parallel to one another. The first and second cooling channels also preferably extend parallel to one another. Furthermore, it is very advantageous if the first cooling channels are offset relative to the second cooling channels in a direction perpendicular to the first direction, which is also referred to hereinafter as the second direction. The second direction is also perpendicular to the extension direction of the cooling channels. This offset advantageously prevents the first and second cooling channels from colliding with one another in case of compression of the intercellular cooling plate. Accordingly, it is advantageous if the first cooling channels on the first inner side have a distance from one another in the second direction that is, in particular, at least as large as a width of the respective second cooling channel(s). This applies accordingly to the second cooling channels and their arrangement on the second inner side.

According to a further advantageous embodiment of the invention, the first cooling channel comprises a cooling channel wall bounding an interior of the cooling channel, and the first expansion limiting component is formed as part of the cooling channel wall or is formed directly adjacent to the cooling channel wall. This enables a particularly space-saving and material-saving design. Nevertheless, it is also conceivable that the first expansion limiting component is embodied separately from the cooling channel wall of the first cooling channel. Incidentally, part of the cooling channel wall of the first cooling channel can be provided by the first plate wall. This applies accordingly to the second cooling channel and the second expansion limiting component.

In addition, multiple first cooling channels can also be embodied in this way. The number of first expansion limiting components can also differ from the number of first cooling channels. For example, only some of the cooling channels can be designed having such an expansion limiting component, in particular as part of their channel wall or as a part directly adjacent to their channel wall. Some of the first cooling channels can also be formed having two first expansion limiting components. Other first cooling channels can be designed without such a first expansion limiting component. The intercellular cooling plate can also comprise differently designed expansion limiting components, for example those that are embodied separately from the cooling channels and those that are embodied as part of the cooling channel walls or directly adjacent to the cooling channel walls.

According to a further advantageous embodiment of the invention, the first expansion limiting component projects further in the direction of the second inner side than the first cooling channel. The same can also apply in turn to the second expansion limiting component with regard to the second cooling channel. When the intercellular cooling plate is compressed, the first expansion limiting component comes into contact first with another part of the intercellular cooling plate, in particular with the second inner side, and not the first cooling channel. This can prevent, in particular, the first cooling channel from coming into contact at all on the second inner side with a part of its channel wall and/or a part of its channel wall that differs from the first expansion limiting component.

This is advantageous in that thermal coupling between the first and second plate walls can thus be reduced to a minimum. Good thermal insulation of the battery cells adjacent to the intercellular cooling plate on both sides is advantageous, for example, in case of thermal runaway of one of these two battery cells.

According to a further advantageous embodiment of the invention, the intercellular cooling plate comprises a first plate component, in particular a first profile component, comprising the first plate wall, the at least one first cooling channel, and the first expansion limiting component, wherein the intercellular cooling plate furthermore comprises a second plate component, in particular a second profile component, comprising the second plate wall, the second expansion limiting component, and in particular at least one second cooling channel, wherein the first plate component has two first edges that are opposite to one another in a second direction and the second plate component has two second edges that are opposite to one another in the second direction, wherein one of the first edges is joined, in particular welded, to one of the second edges in each case. In this way, the intercellular cooling plate can be manufactured very easily from two plate components, for example, profile components, which are joined together, in particular welded. The formation of the intercellular cooling plate from these two plate components is particularly possible even if the intercellular cooling plate does not comprise any expansion limiting components.

A profile component is understood to be a component which always has the same cross section perpendicular to a certain direction, which in the present case is called the third direction. The third direction thus also corresponds to the extension direction of the at least one first cooling channel, and in particular also to the extension direction of all optional further cooling channels.

However, the plate components do not necessarily have to be provided or designed as profile components, but can also be manufactured in other ways. In particular, they can also be formed having a cross section that is not always the same, perpendicular to the third direction.

The intercellular cooling plate can also be designed having a coolant supply connection and a coolant discharge connection in order to supply and discharge coolant to and from the at least one first cooling channel and the optional at least one second cooling channel. These connections can be arranged in one of the two end regions of the intercellular cooling plate or at both end regions of the intercellular cooling plate that define the intercellular cooling plate with respect to the third direction. Furthermore, the intercellular cooling plate can also be part of an intercellular cooling unit comprising two end pieces arranged at the two ends of the intercellular cooling plate, which bound the intercellular cooling plate in and against the third direction. Such end pieces can also be used, for example, to implement the connections for coolant supply and discharge from the respective cooling channels. However, such coolant supply and discharge connections can also be implemented via only one of the two end pieces, with the other being used only to seal and/or fluidically connect two cooling channels of the intercellular cooling plate.

The coolant is preferably a liquid coolant. During operation of the battery, if cooling or temperature control is required, the coolant can accordingly be guided or pumped through the at least one first cooling channel of the intercellular cooling plate.

Furthermore, the invention also relates to a battery having an intercellular cooling plate according to the invention or one of its embodiments. The battery comprises, in particular, at least two battery cells, between which the intercellular cooling plate is arranged. The battery can in particular also comprise a first cell row which has multiple first battery cells arranged adjacent to one another in the third direction. In addition, the battery can comprise a second cell row which comprises multiple second battery cells arranged adjacent to one another in the third direction. The intercellular cooling plate can be positioned between the two cell rows and extend in the third direction as far as the two cell rows. The first battery cells of the first cell row can accordingly be adjacent to the first plate wall, and the second battery cells of the second cell rows to the second plate wall. A particularly efficient structure of the battery can thus be implemented.

The battery cells can be designed as prismatic battery cells, for example. The battery can be designed, for example, as a high-voltage battery. In particular, the battery cells can be formed as lithium-ion cells, for example.

Furthermore, the invention also relates to a motor vehicle having a battery according to the invention or one of its embodiments. The motor vehicle can be designed as an electric vehicle, for example.

The motor vehicle according to the invention is preferably designed as an automobile, in particular as a passenger car or truck, or as a passenger bus or motorcycle.

Furthermore, the invention relates to a method for producing an intercellular cooling plate for a battery, wherein the intercellular cooling plate is designed comprising an interior having at least one first cooling channel through which a cooling can flow, a first plate wall, and a second plate wall which are opposite to one another with respect to a first direction and which bound the interior in and against the first direction. In addition, the intercellular cooling plate is designed so that at least one pressure chamber separated from a cooling channel, which is filled with a fluid having a specific fluid pressure, is arranged in the interior.

The intercellular cooling plate can be formed, for example, from two plate components, e.g., profile components or half-shells having structural elements that form the cooling channels and/or expansion limiting components, which are pushed into one another in the third direction. The plate components can then be joined together, in particular joined together at the edges, for example by welding them together.

Furthermore, it is very advantageous if the intercellular cooling plate or at least the plate walls are made of a metallic material, for example, aluminum. In principle, the intercellular cooling plate can be made of any material, however, for example, plastic, or comprise such a different material.

The invention also includes refinements of the method according to the invention, which have features as have already been described in conjunction with the refinements of the intercellular cooling plate according to the invention. For this reason, the corresponding developments of the method according to the invention are not described again here.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In the figures:

FIG. 1 shows a schematic cross-sectional representation of an intercellular cooling plate according to an exemplary embodiment of the invention;

FIG. 2 shows a schematic cross-sectional representation of a part of the intercellular cooling plate of FIG. 1 upon compression, according to an exemplary embodiment of the invention;

FIG. 3 shows a schematic representation of a battery according to an exemplary embodiment of the invention.

FIG. 4 shows a schematic cross-sectional representation of a part of an intercellular cooling plate according to a further exemplary embodiment of the invention; and

FIG. 5 shows a schematic representation of a part of an intercellular cooling plate according to a further exemplary embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also refine the invention independently of one another. Therefore, the disclosure is also intended to comprise combinations of the features of the embodiments other than those illustrated. Furthermore, the described embodiments can also be supplemented by further ones of the above-described features of the invention.

In the figures, same reference numerals respectively designate elements that have the same function.

The figures depict coordinate systems. The x direction shown here corresponds to the above-mentioned first direction, the z direction shown to the above-mentioned second direction, and the y direction shown to the above-mentioned third direction. In particular, the z direction corresponds to a vehicle vertical direction with respect to a preferred installation position of the intercellular cooling plate or the battery in a motor vehicle.

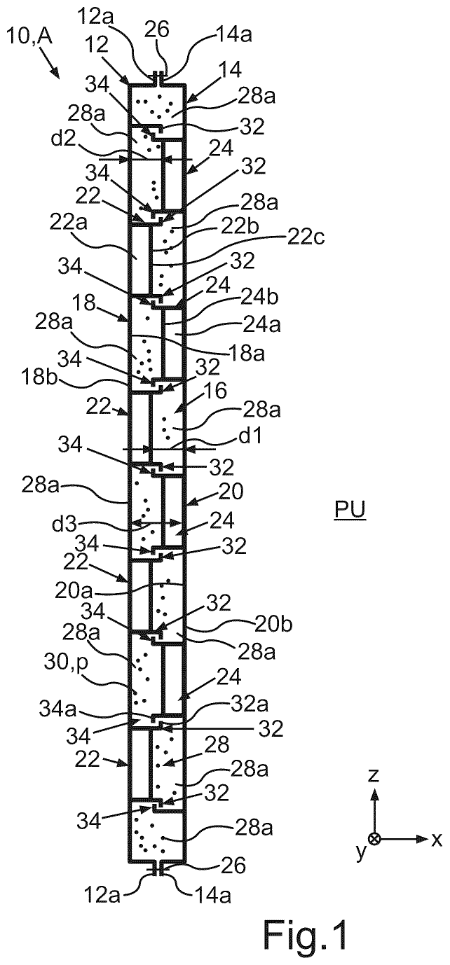

FIG. 1 shows a schematic cross-sectional representation of an intercellular cooling plate (10) according to an exemplary embodiment of the invention. The intercellular cooling plate 10 comprises a first plate component 12, for example, a first profile component 12, and a second plate component 14, for example, a second profile component 14. The intercellular cooling plate 10 also comprises an interior 16. The first profile component 12 furthermore comprises a first plate wall 18, and the second profile component 14 comprises a second plate wall 20. The first plate wall 18 has an inner side 18a facing toward the interior 16 and an outer side 18b facing away from the interior 16. The second plate wall 20 also has an inner side 20a facing toward the interior and an outer side 20b facing away from the interior 16. The interior 16 is bounded by the two plate walls 18, 20 in and against the x direction. The interior 16 contains at least one first cooling channel 22 and, in the present example, multiple first cooling channels 22. The first cooling channels 22 are arranged on the first inner side 18a of the first plate wall 18. The first cooling channels 22 comprise a cooling channel interior 22a and a cooling channel wall 22b. A coolant can flow through the interior of the cooling channel 22a. As shown here, part of the channel wall 22b can be provided by the first plate wall 18. In particular, the first cooling channels 22 can also be part of the first profile component 12 and thus can be integrally formed with the first plate wall 18. Furthermore, in this example, the intercellular cooling plate 10 also comprises multiple second cooling channels 24. These also comprise a cooling channel interior 24a and a channel wall 24b. Part of the channel wall 24b can also be provided here by the second plate wall 20. In particular, the second cooling channels 24 are also part of the profile component 14 and are therefore integrally formed with the plate wall 20. The first profile component 12 also comprises two first edges 12a opposite to one another with respect to the z-direction and the second profile component 14 comprises two second edges 14a opposite to one another with respect to the z-direction. The two profile components 12, 14 are joined together in the area of their edges 12a, 14a, in particular joined fluid-tight, for example, welded. For example, weld seams are designated by 26 in the present case. The intercellular cooling plate 10 now advantageously comprises a pressure chamber 28 separated from the cooling channels 22, 24. This chamber can in particular be divided into individual chambers 28a, which are, however, fluidically connected to one another. The entirety of these chambers 28a thus forms the pressure chamber 28. The pressure chamber 28 borders directly on the first plate wall 18 on one side and directly on the second plate wall 20 on the other. The pressure chamber 28 is filled with a fluid 30, in particular with a gas that has a fluid pressure p. The fluid 30 is enclosed in the pressure chamber 28, in particular permanently enclosed. For this purpose, the intercellular cooling plate can be sealed accordingly at its ends opposite to one another with respect to the y-direction. This sealing does not necessarily have to be provided by the profile components 12, 14, but can be provided by one or more separate components (not shown here), for example, corresponding end pieces, which can also provide coolant supply and discharge connections for the coolant supply and discharge of the coolant flowing through the cooling channels 22, 24.

The fluid pressure p is preferably to be greater than the ambient pressure PU or the normal pressure. In order to avoid excessive swelling of the intercellular cooling plate and excessive deformation of the plate walls 18, 20 during the manufacturing of the intercellular cooling plate and in particular during the filling of the pressure chamber 28 with the fluid 30, the intercellular cooling plate advantageously comprises expansion limiting components 32, 34.

The first cooling channels 22 are designed such that, in the initial state A of the intercellular cooling plate 10 shown here, they have a distance d1 to the second inner surface 20a. The second cooling channels 24 are also designed such that in this initial state A they have a distance d2 from the first inner side 20a. Furthermore, the first cooling channels 22 are arranged offset in the z direction relative to the second cooling channels 24. The first cooling channels 22 have a distance to one another in the z direction, as do the second cooling channels 24. This allows the intercellular cooling plate 10 to be compressed with respect to the x direction without the first cooling channels 22 colliding with the second cooling channels 24. This enables greater compression of the intercellular cooling plate 10. Furthermore, the fluid pressure p of the fluid 30 in the pressure chamber 28 counteracts such compression. The compression properties can thus be advantageously adjusted or appropriately selected via the fluid pressure p in the pressure chamber 28.

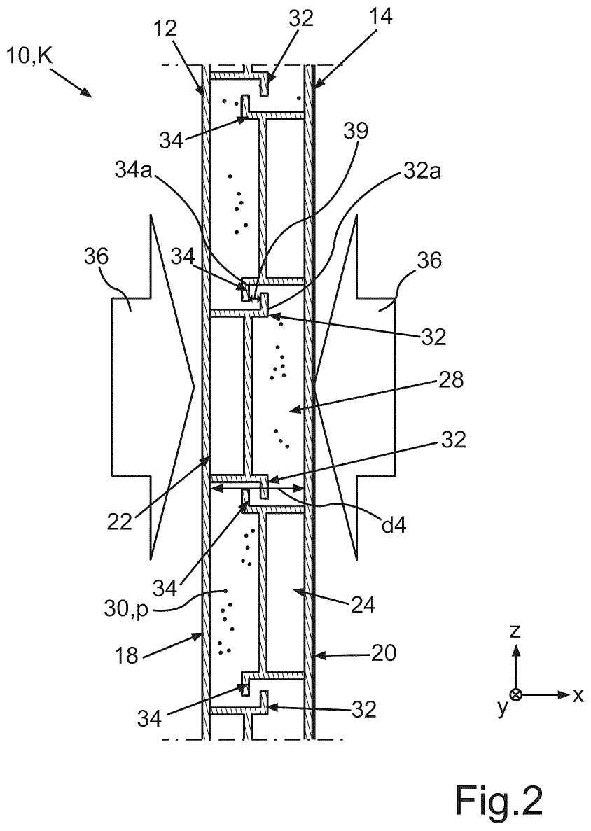

The expansion limiting components 32, 34 now advantageously ensure that the two plate walls 18, 20 do not move excessively far apart, in particular during the production of the intercellular cooling plate 10 or during the filling of the pressure chamber 28 with the fluid 30. Furthermore, the expansion limiting components 32, 34 are designed in such a way that a certain compression of the intercellular cooling plate 10 starting from the initial state A is possible. This is illustrated again, for example, in FIG. 2.

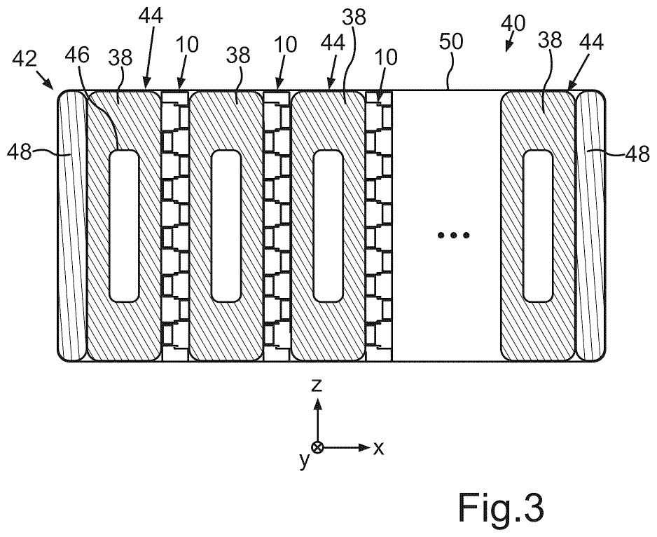

FIG. 2 shows a schematic representation of part of the intercellular cooling plate 10 from FIG. 1 after compression. The intercellular cooling plate 10 is therefore in a compressed state K, in which the cooling plate 10 is more compressed than in its initial state A, in particular compressed with respect to the x direction. Such a compressed state K can occur when the battery cells 38 adjacent to the plate walls 18, 20 (cf. FIG. 3) are charged and the force on the heat sink, i.e. the intercellular cooling plate 10, increases. This causes it to be compressed and the fluid pressure p increases. The arrows 36 illustrate, for example, swelling forces that act on the intercellular cooling plate 10 during cell swelling of the battery cells 38 adjacent to the plate walls 18, 20. This reduces the distance between the plate walls 18, 20. The distance d3 between the plate walls 18, 20 shown in FIG. 1 refers to the initial state A of the intercellular cooling plate 10, and the reduced distance d4 between the plate walls 18, 20 shown in FIG. 2 refers to a state of compression of the intercellular cooling plate 10 in relation to the initial state A. The hooked ends 32a, 34a and the angled ends 32a, 34a of the expansion limiting components 32, 34, as embodied in this example, can therefore move apart in the x direction when the intercellular cooling plate 10 is compressed, due to their shape. The relative motion between the ends 32a, 34a is illustrated by the double arrow 39. When the battery cells 38 discharge again, they subside, the force on the intercellular cooling plate 10 decreases and the intercellular cooling plate 10 is pushed apart again due to the internal pressure p and can, for example, return approximately to the initial state A, as shown in FIG. 1.

If, instead, the plate walls 18, 20 move away from one another with respect to the x direction, this movement is limited by the resulting form fit between the two mutually associated expansion limiting components 32, 34. In other words, the plate walls 18, 20 can only be moved apart until the expansion limiting components 32, 34 form a form fit with one another and thus limit or prevent further movement away from one another. In this example, the form fit is formed by the hooked ends 32a, 34a coming into contact with one another or hooking into one another. This makes it possible to initially provide the pressure chamber 28 with a very high fluid pressure p.

Furthermore, in this example, the expansion limiting components 32, 34 are arranged directly adjacent to the respective walls 22b, 24b of the cooling channels 22, 24. This saves material and installation space. Furthermore, the first expansion limiting component 32 projects further in the direction the second inner surface 20a than the relevant cooling channel 22. In other words, the first expansion limiting component 32 has a smaller distance to the second inner surface 20a at all times than the cooling channel 22, in particular its end face 22c facing toward the second inner surface 20a. The same applies to the second expansion limiting components 34 and the second cooling channels 24. With increasing compression of the intercellular cooling plate 10 with respect to the x direction, the first expansion limiting component 32 first comes into contact with the second inner side 20a before the first cooling channel 22, in particular its end face 22c, can come into contact with the second inner side 20a. More precisely, this can prevent the end face 22c from coming into contact with the second inner side 20a, even under strong compression. Even under strong compression, this minimizes the contact area between the first and second plate components 12, 14.

FIG. 3 shows a schematic representation of a battery 40 according to an exemplary embodiment of the invention. The battery 40 comprises multiple battery cells 38, which are arranged adjacent to one another in the x direction. The battery 40 thus comprises a cell stack 42 having multiple battery cells 38 arranged adjacent to one another in a stack direction, wherein the stack direction corresponds to the x direction shown. Each battery cell 38 can optionally also be part of a cell row 44 having multiple battery cells 38 arranged adjacent to one another in the y direction. An intercellular cooling plate 10 is arranged between each two battery cells 38 or cell rows 44 arranged adjacent to one another in the stack direction x. This can be designed as described above.

The intercellular cooling plate 10 extends in the y direction as far as the battery cells 38 or the cell rows 44. Thus, multiple battery cells 38 of the same cell row 44 can adjoin the first plate wall 18, and similarly, multiple battery cells 38 of another cell row 44 can adjoin the second plate wall 20.

The battery cells 38 are designed in the present case as prismatic battery cells. Each battery cell 38 comprises two cell poles 46, only one of which is visible of each of the battery cells 38 shown here. The battery cells 38 in the cell row 44 are therefore arranged adjacent to one another in the y direction with their cell poles 46 facing toward one another.

In addition, the battery 40 comprises two end plates 48, which delimit the cell stack 42 in and against the x direction. Furthermore, the battery 40 is surrounded by a tension band 50. In other words, the tension band 50 surrounds the cell stack 42 as well as the end plates 48. A defined pressure can thus be applied to the cell stack 42 in the x direction via this tension band 50.

The plate components 12, 14, in particular the expansion limiting components 32, 34, can also be implemented geometrically differently, as explained in more detail below.

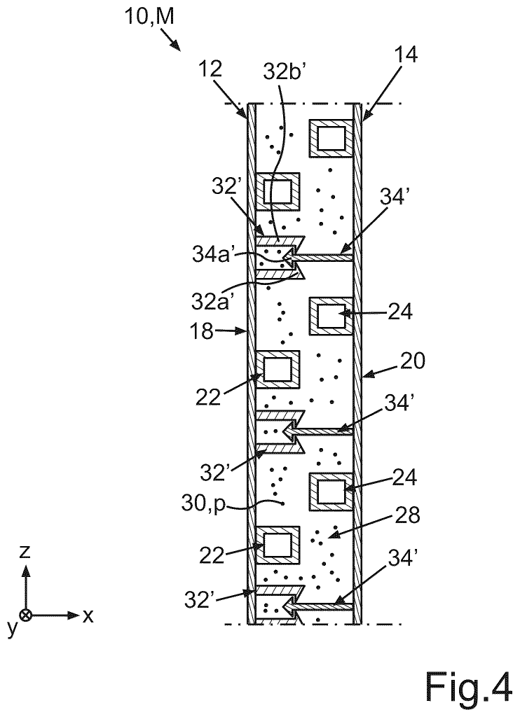

FIG. 4 shows a schematic representation of part of an intercellular cooling plate 10 according to a further exemplary embodiment of the invention. The first expansion limiting components are designated in the present case by 32′ and the second expansion limiting components by 34′. In this example, the first and second expansion limiting components 32′, 34′ are designed separately from the cooling channels 22, 24, meaning they are not directly adjacent to their channel walls 22b, 24b, and, independently of the separate design, the expansion limiting components 32′, 34′ are also geometrically different. The second expansion limiting component has an end 34a′ which is embodied having a double hook, and the first expansion limiting component 32′ comprises two rails 32b′ opposite to one another with respect to the z direction, which have a distance from one another in the z direction, and whose ends 32a′ are embodied having hooks directed toward one another. In the maximally expanded state M of the intercellular cooling plate, these hooks 32a′ are engaged in a formfitting manner with the double hook 34a′ and prevent further movement of the plate walls 18, 20 away from one another. In contrast, a movement of the plates 18, 20 towards one another is possible, at least until the respective expansion limiting components 32′, 34′ come into contact on the respective opposite wall. This design of the expansion limiting components 32′, 34′ also advantageously enables the manufacture of the intercellular cooling plate 10 by providing, for example, two profile components 12, 14, or plate components 12, 14 manufactured in a different manner, which are pushed into one another in the y direction.

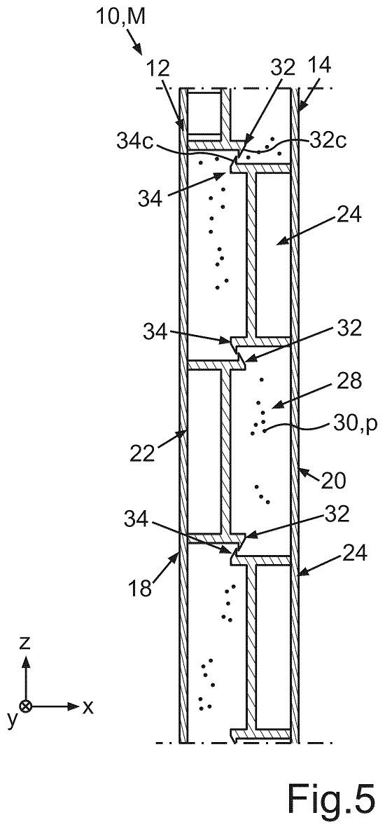

FIG. 5 shows a schematic cross-sectional representation of a part of an intercellular cooling plate 10 according to a further exemplary embodiment of the invention. This too is in its maximally expanded state M in the illustration. The expansion limiting components 32, 34 are again designed as described for FIG. 1 and FIG. 2, except that their respective ends 32a, 32b are designed having a respective bevel 32c, 34c. This allows the intercellular cooling plate to be assembled, for example, in such a way that the profile components 12, 14 are moved towards one another with respect to the x direction, due to which the bevels 32c, 34c allow the expansion-limiting components 32, 34 to slide past one another by slight deformation or bending until the hooked ends 32a, 34a snap into one another or hook behind one another. Further movement of the plates 18, 20 towards one another with respect to the x direction is then still possible, in particular until the expansion limiting components 32, 34 in turn come into contact with the respective opposite walls 18, 20. However, an opposite movement away from one another from the maximally expanded state M of the plates 18, 20 shown here is no longer possible, since this is again prevented by the form fit of the hooked ends 32a, 34a.

Overall, the examples show how the invention provides a heat sink design for pressure-related swelling compensation. For this purpose, a cooling plate, namely the intercellular cooling plate, which can also be called a heat sink, can be provided with an additional chamber, namely the pressure chamber, in addition to the channels, i.e. the cooling channels. This chamber can be filled with a gas at a preset pressure during the manufacturing process of the cooling plate. The cooling channel and the pressure chamber are separate from one another, but are implemented in one component. The heat sink can be made from two shells, which were previously also called plate components, or from a continuous profile, or from two profile components. An aluminum extrusion profile is preferred. Before installing such a system, i.e. the intercellular cooling plate, in a battery, such as a high-voltage battery, a pre-pressure can already be set during the production of the cooling element. This allows the outer surfaces of the heat sink to be pressed apart to a target dimension. The heat sink can be geometrically designed such that the pre-pressure cannot deform it beyond the desired extent. For this purpose, interlocking hooks can be provided in the heat sink, which were previously also referred to as expansion limiting components. The interlocking areas provided by the expansion limiting components can prevent or limit swelling of the heat sink. During assembly of the battery, the heat sink can be positioned between the cells, in particular prismatic cells, and the entire stack or module, or more generally the cell stack, can then be pre-tensioned to a defined force level. The heat sink can be compressed to varying degrees due to cell tolerances until the required pre-tension is achieved. During the operating life of the high-voltage battery, growth occurs in the cells due to cycling. This growth can then be compensated for in the pressure chambers of the heat sink by increasing the pressure. Cellular respiration occurs during the charging and discharging of the cell. This is largely reversible. The swelling then returns to approximately its initial state. An irreversible swelling component, the aging swelling, remains. This age-related swelling increases steadily over both a temporal and a cyclical component. Regardless of the state of charge and the state of aging, the optimal counter pressure can thus be applied to the cells, so that the lifespan of the cell is maximized. This enables active, optimized control of the pressure on the cells.

1. An intercellular cooling plate for positioning between at least two battery cells of a battery, comprising:
an interior having at least one first cooling channel through which a coolant can flow,
a first plate wall, and a second plate wall, which are opposite to one another with respect to a first direction and which bound the interior in and against the first direction, and
at least one pressure chamber separated from the cooling channel, which is filled with a fluid having a specific fluid pressure, is arranged in the interior.

2. The intercellular cooling plate as claimed in claim 1, wherein the fluid is at least partly a gas.

3. The intercellular cooling plate as claimed in claim 1, wherein the pressure chamber is adjacent to the first and second plate wall.

4. The intercellular cooling plate as claimed in claim 1, wherein the intercellular cooling plate is compressible with respect to the first direction and with respect to a defined initial state, in particular elastically compressible, in particular in such a way that a distance between the first and second plate wall is reducible in at least one area of the intercellular cooling plate in relation to an initial distance that the first and second plate wall have in the defined initial state.

5. The intercellular cooling plate as claimed in claim 1, wherein the first plate wall has a first inner side facing toward the interior and the second plate wall has a second inner side facing toward the interior, wherein a first expansion limiting component is arranged in the first inner side and a second expansion limiting component is arranged in the second inner side,
wherein an increase of a distance between the first and second plate wall can be limited at least locally by means of the first and second expansion limiting component; and/or
wherein a form fit can be formed by means of the first and second expansion limiting component when a distance between the first and second plate wall increases.

6. The intercellular cooling plate as claimed in claim 5, wherein the first expansion limiting component has a hooked first end facing toward the second inner side, which is designed to form a form fit with at least a part of the second expansion limiting component, in particular wherein the second expansion limiting component has a hooked second end facing toward the first inner side, which can be engaged in a form fit with the first end.

7. The intercellular cooling plate as claimed in claim 1, wherein the at least one first cooling channel is arranged on the first inner side and, at least in a defined initial state of the intercellular cooling plate has a distance to the second inner side.

8. The intercellular cooling plate as claimed in claim 1, wherein the first cooling channel comprises a cooling channel wall bounding an interior of the cooling channel, and the first expansion limiting component is formed as part of the cooling channel wall or is formed directly adjacent to the cooling channel wall.

9. The intercellular cooling plate as claimed in claim 5, wherein the first expansion limiting component projects further in the direction of the second inner side than the first cooling channel.

10. The intercellular cooling plate as claimed in claim 1, wherein the intercellular cooling plate comprises a first plate component, in particular a profile component, comprising the first plate wall, the at least one first cooling channel, and the first expansion limiting component, and comprises a second plate component, in particular a second profile component, comprising the second plate wall, the second expansion limiting component, and in particular at least one second cooling channel, wherein the first plate component has two first edges that are opposite to one another in a second direction and the second plate component has two second edges that are opposite to one another in the second direction, wherein one of the first edges is joined, in particular welded, to one of the second edges in each case.

11. A battery having an intercellular cooling plate as claimed in claim 1, wherein the battery comprises the at least two battery cells, between which the intercellular cooling plate is arranged.

12. A motor vehicle having a battery as claimed in claim 11.

13. A method for producing an intercellular cooling plate for a battery, wherein the intercellular cooling plate is formed
having an interior having at least one first cooling channel through which a coolant can flow, and
having a first plate wall and having a second plate wall that are opposite to one another with respect to a first direction and bound the interior in and against the first direction,
wherein the intercellular cooling plate is designed so that at least one pressure chamber separated from the cooling channel, which is filled with a fluid having a specific fluid pressure, is arranged in the interior.

14. The intercellular cooling plate as claimed in claim 2, wherein the pressure chamber is adjacent to the first and second plate wall.

15. The intercellular cooling plate as claimed in claim 2, wherein the intercellular cooling plate is compressible with respect to the first direction and with respect to a defined initial state, in particular elastically compressible, in particular in such a way that a distance between the first and second plate wall is reducible in at least one area of the intercellular cooling plate in relation to an initial distance that the first and second plate wall have in the defined initial state.

16. The intercellular cooling plate as claimed in claim 3, wherein the intercellular cooling plate is compressible with respect to the first direction and with respect to a defined initial state, in particular elastically compressible, in particular in such a way that a distance between the first and second plate wall is reducible in at least one area of the intercellular cooling plate in relation to an initial distance that the first and second plate wall have in the defined initial state.

17. The intercellular cooling plate as claimed in claim 2, wherein the first plate wall has a first inner side facing toward the interior and the second plate wall has a second inner side facing toward the interior, wherein a first expansion limiting component is arranged in the first inner side and a second expansion limiting component is arranged in the second inner side,
wherein an increase of a distance between the first and second plate wall can be limited at least locally by means of the first and second expansion limiting component; and/or
wherein a form fit can be formed by means of the first and second expansion limiting component when a distance between the first and second plate wall increases.

18. The intercellular cooling plate as claimed in claim 3, wherein the first plate wall has a first inner side facing toward the interior and the second plate wall has a second inner side facing toward the interior, wherein a first expansion limiting component is arranged in the first inner side and a second expansion limiting component is arranged in the second inner side,
wherein an increase of a distance between the first and second plate wall can be limited at least locally by means of the first and second expansion limiting component; and/or
wherein a form fit can be formed by means of the first and second expansion limiting component when a distance between the first and second plate wall increases.

19. The intercellular cooling plate as claimed in claim 4, wherein the first plate wall has a first inner side facing toward the interior and the second plate wall has a second inner side facing toward the interior, wherein a first expansion limiting component is arranged in the first inner side and a second expansion limiting component is arranged in the second inner side,
wherein an increase of a distance between the first and second plate wall can be limited at least locally by means of the first and second expansion limiting component; and/or
wherein a form fit can be formed by means of the first and second expansion limiting component when a distance between the first and second plate wall increases.

20. The intercellular cooling plate as claimed in claim 2, wherein the at least one first cooling channel is arranged on the first inner side and, at least in a defined initial state of the intercellular cooling plate has a distance to the second inner side.
